(19) United States
(12) Patent Application Publication
(10) Pub. No.: US 2026/0116365 A1
(43) Pub. Date: Apr. 30, 2026

(54) ELECTRIC BRAKE SYSTEM AND METHOD OF CONTROLLING THE SAME

(71) Applicant: HL MANDO CORPORATION, Pyeongtaek-si (KR)

(72) Inventors: Yeonseong KIM, Pyeongtaek-si (KR); Kiwon KANG, Pyeongtaek-si (KR); Inwook JEON, Pyeongtaek-si (KR)

(21) Appl. No.: 19/020,515

(22) Filed: Jan. 14, 2025

(30) Foreign Application Priority Data
Oct. 30, 2024 (KR) 10-2024-0150874

(51) Int. Cl. B60T 13/68; B60T 7/04; B60T 8/40

(52) U.S. Cl. CPC B60T 13/686; B60T 7/042; B60T 8/4081; B60T 2270/413

(57) ABSTRACT

An electric brake system including an integrated master cylinder, a hydraulic pressure supply device configured to generate a hydraulic pressure of a pressing medium, and an auxiliary brake module configured to provide the hydraulic pressure to a first wheel cylinder and a second wheel cylinder, wherein the auxiliary brake module may include a pump configured to press the pressing medium, a motor configured to operate the pump, a first auxiliary flow path configured to transfer the pressing medium pressed by the pump to the first wheel cylinder, a first auxiliary supply flow path provided to supply the pressing medium to the pump, a first auxiliary supply valve provided on the first auxiliary supply flow path to control the pressing medium to be supplied to the pump, and a first pressure control valve configured to control a pressure of the first auxiliary flow path.

### CROSS-REFERENCE TO RELATED APPLICATION

This application claims the benefit of Korean Patent Application No. 2024-0150874, filed on October 30, 2024, in the Korean Intellectual Property Office, the disclosure of which is incorporated herein by reference.

### BACKGROUND

### Technical Field

The present disclosure relates to an electric brake system and a method of controlling the same.

### Description of the Related Art

Vehicles are essentially provided with a brake system for braking, and various types of brake systems have been proposed for the safety of drivers and passengers.

Conventional brake systems mainly use a method of supplying a hydraulic pressure required for braking to wheel cylinders using a mechanically connected booster when a driver steps on a brake pedal. However, as the market demand for implementing various braking functions in detail in response to operating environments of a vehicle increases, electric brake systems, which receive the braking intention of a driver as an electrical signal from a pedal displacement sensor for detecting the displacement of a brake pedal when the driver steps on the brake pedal and accordingly operate a hydraulic pressure supply device to supply a hydraulic pressure required for braking to wheel cylinders, have recently become widespread.

Such an electric brake system receives a brake pedal operation or braking determination of the driver during autonomous driving of the vehicle as an electrical signal and accordingly electrically operates and controls the hydraulic pressure supply device to generate the hydraulic pressure required for braking and transmit the hydraulic pressure to the wheel cylinders.

Such an electric brake system and a method of controlling the same are electrically operated and controlled and can implement complex and diverse braking operations. However, when a technical problem occurs in electric components, the hydraulic pressure required for braking cannot be stably generated, which can threaten the safety of occupants of a vehicle.

Accordingly, the electric brake system enters an abnormal operation mode when one component fails or is in an uncontrollable state, and at this time, a mechanism in which the brake pedal operation of the driver needs to be directly linked to the wheel cylinders.

In addition, there is a need for a method of implementing stable braking of the vehicle even before the driver operates the brake pedal after the electric brake system enters the abnormal operation mode.

In addition, there is a need for a method of performing active braking, such as an anti-lock brake system (ABS) mode of a vehicle and the like so that the vehicle can perform stable braking and stable behavior even in the abnormal operation mode of the electric brake system.

### BRIEF SUMMARY

Therefore, it is an aspect of the present disclosure to provide an electric brake system capable of effectively performing braking even in various operation situations of a vehicle, and a method of controlling the same.

It is another aspect of the present disclosure to provide an electric brake system with improved braking performance and operation reliability, and a method of controlling the same.

It is another aspect of the present disclosure to provide an electric brake system capable of performing various braking operation modes through a simple structure and operation, and a method of controlling the same.

It is another aspect of the present disclosure to provide an electric brake system capable of improving assemblability and productivity of a product and reducing manufacturing costs, and a method of controlling the same.

Additional aspects of the disclosure will be set forth in part in the description which follows and, in part, will be obvious from the description, or may be learned by practice of the disclosure.

In accordance with one aspect of the present disclosure, an electric brake system includes an integrated master cylinder configured to discharge a pressing medium based on a pedal force of a brake pedal, a hydraulic pressure supply device configured to generate a hydraulic pressure of the pressing medium based on an electrical signal of a pedal displacement sensor for the brake pedal, and an auxiliary brake module configured to provide the hydraulic pressure to a first wheel cylinder and a second wheel cylinder among a plurality of wheel cylinders, wherein the auxiliary brake module may include a pump configured to press the pressing medium, a motor configured to operate the pump, a first auxiliary flow path configured to transfer the pressing medium pressed by the pump to the first wheel cylinder, a first auxiliary supply flow path provided to supply the pressing medium to the pump, a first auxiliary supply valve provided on the first auxiliary supply flow path to control the pressing medium to be supplied to the pump, and a first pressure control valve configured to control a pressure of the first auxiliary flow path.

The auxiliary brake module may further include a second auxiliary flow path configured to transfer the pressing medium pressed by the pump to the second wheel cylinder, a second auxiliary supply flow path provided to supply the pressing medium to the pump, a second auxiliary supply valve provided on the second auxiliary supply flow path to control the pressing medium to be supplied to the pump, and a second pressure control valve configured to control a pressure of the second auxiliary flow path.

The electric brake system may further include a control circuit configured to close the first pressure control valve and the second pressure control valve, open the first auxiliary supply valve and the second auxiliary supply valve, and control the motor to operate the pump upon receiving a braking request from an external controller while the hydraulic pressure supply device is inoperable.

The control circuit may open the first pressure control valve and the second pressure control valve, close the first auxiliary supply valve and the second auxiliary supply valve, and control the motor to stop the operation of the pump upon receiving the braking request from a brake pedal while the hydraulic pressure supply device is inoperable.

The control circuit may control a driving current supplied to the first pressure control valve and the second pressure control valve based on a pressure corresponding to the braking request from the external controller.

When the hydraulic pressure supply device is inoperable, in a fallback mode, the first pressure control valve and the second pressure control valve may each be in an open state, and the first auxiliary supply valve and the second auxiliary supply valve may each be in a closed state.

When the hydraulic pressure supply device is inoperable, in a cross-control mode of a first wheel provided with the first wheel cylinder and a second wheel provided with the second wheel cylinder, the control circuit may repeat first control for opening the first pressure control valve, closing the first auxiliary supply valve, closing the second pressure control valve, and opening the second auxiliary supply valve, and second control for closing the first pressure control valve, opening the first auxiliary supply valve, opening the second pressure control valve, and closing the second auxiliary supply valve, and control the motor to operate the pump during repetition of the first control and the second control.

The integrated master cylinder may include a first master piston provided to be displaced by operation of the brake pedal, a first master chamber whose volume is changed by the displacement of the first master piston, a second master piston provided to be displaced by the displacement of the first master piston or a hydraulic pressure of the first master chamber, and a second master chamber whose volume is changed by the displacement of the second master piston.

The electric brake system may further include a reservoir, a first reservoir flow path connecting the first master chamber to the reservoir, a second reservoir flow path connecting the second master chamber to the reservoir, and a third reservoir flow path connected to the first auxiliary supply flow path and the second auxiliary supply flow path to allow the pump to communicate with the reservoir.

The electric brake system may further include a first connection flow path provided with the first pressure control valve to connect the first wheel cylinder to the master cylinder, and a second connection flow path provided with the second pressure control valve to connect the second wheel cylinder to the master cylinder.

In accordance with one aspect of the present disclosure, an electric brake system may include a main brake module connected to a brake pedal and mechanically and electronically operated and controlled to supply a hydraulic pressure of a pressing medium to a plurality of wheel cylinders, an auxiliary brake module including a pump configured to press the pressing medium, a motor configured to operate the pump, a first auxiliary flow path and a second auxiliary flow path that transfer the pressing medium pressed by the pump to a first wheel cylinder and a second wheel cylinder, respectively, among the plurality of wheel cylinders, a first auxiliary supply flow path and a second auxiliary supply flow path provided to supply the pressing medium to the pump, a first auxiliary supply valve provided on the first auxiliary supply flow path to control the pressing medium to be supplied to the pump, a second auxiliary supply valve provided on the second auxiliary supply flow path to control the pressing medium to be supplied to the pump, and a first pressure control valve and a second pressure control valve configured to control pressures of the first auxiliary flow path and the second auxiliary flow path, and a control circuit configured to control at least one of the first pressure control valve, the second pressure control valve, the first auxiliary supply valve, the second auxiliary supply valve, or the motor of the auxiliary brake module while the main brake module is inoperable.

The control circuit may close the first pressure control valve and the second pressure control valve, open the first auxiliary supply valve and the second auxiliary supply valve, and control the motor to operate the pump upon receiving a braking request from an external controller while the hydraulic pressure supply device is inoperable.

The control circuit may open the first pressure control valve and the second pressure control valve, close the first auxiliary supply valve and the second auxiliary supply valve, and control the motor to stop the operation of the pump upon receiving the braking request from a brake pedal while the hydraulic pressure supply device is inoperable.

The control circuit may control a driving current supplied to the first pressure control valve and the second pressure control valve based on a pressure corresponding to the braking request from the external controller.

When the hydraulic pressure supply device is inoperable, in a fallback mode, the first pressure control valve and the second pressure control valve may each be in an open state, and the first auxiliary supply valve and the second auxiliary supply valve may each be in a closed state.

In accordance with one aspect of the present disclosure, a method of controlling an electric brake system, which includes a main brake module connected to a brake pedal and mechanically and electronically operated and controlled to supply a hydraulic pressure of a pressing medium to a plurality of wheel cylinders, and an auxiliary brake module including a pump configured to press the pressing medium, a motor configured to operate the pump, a first auxiliary flow path and a second auxiliary flow path that transfer the pressing medium pressed by the pump to a first wheel cylinder and a second wheel cylinder, respectively, among the plurality of wheel cylinders, a first auxiliary supply flow path and a second auxiliary supply flow path provided to supply the pressing medium to the pump, a first auxiliary supply valve provided on the first auxiliary supply flow path to control the pressing medium to be supplied to the pump, a second auxiliary supply valve provided on the second auxiliary supply flow path to control the pressing medium to be supplied to the pump, and a first pressure control valve and a second pressure control valve configured to control pressures of the first auxiliary flow path and the second auxiliary flow path, includes closing the first pressure control valve and the second pressure control valve and opening the first auxiliary supply valve and the second auxiliary supply valve upon receiving a braking request from an external controller while the main brake module is inoperable, and controlling the motor to operate the pump based on the closing of the first pressure control valve and the second pressure control valve and the opening of the first auxiliary supply valve and the second auxiliary supply valve.

The method may further include opening the first pressure control valve and the second pressure control valve, closing the first auxiliary supply valve and the second auxiliary supply valve, and controlling the motor to stop the operation of the pump upon receiving the braking request from a brake pedal while the hydraulic pressure supply device is inoperable.

The method may further include controlling a driving current supplied to the first pressure control valve and the second pressure control valve based on a pressure corresponding to the braking request from the external controller.

When the hydraulic pressure supply device is inoperable, in a fallback mode, the first pressure control valve and the second pressure control valve may each be in an open state, and the first auxiliary supply valve and the second auxiliary supply valve may each be in a closed state.

The method may further include, when the hydraulic pressure supply device is inoperable, in a cross-control mode of a first wheel provided with the first wheel cylinder and a second wheel provided with the second wheel cylinder, repeating first control for opening the first pressure control valve, closing the first auxiliary supply valve, closing the second pressure control valve, and opening the second auxiliary supply valve, and second control for closing the first pressure control valve, opening the first auxiliary supply valve, opening the second pressure control valve, and closing the second auxiliary supply valve, and controlling the motor to operate the pump during repetition of the first control and the second control.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a hydraulic pressure circuit diagram illustrating an electric brake system according to one embodiment;

FIG. 2 is a block diagram illustrating a configuration of a control circuit of the electric brake system according to one embodiment;

FIG. 3 is a view illustrating a supply path of a pressing medium according to the control of an auxiliary brake module of the electric brake system according to one embodiment;

FIG. 4 is a view illustrating the supply path of the pressing medium according to the control of the auxiliary brake module of the electric brake system according to one embodiment;

FIG. 5 is a view illustrating a discharge path and a pressure release path of the pressing medium according to the control of the auxiliary brake module of the electric brake system according to one embodiment; and

FIG. 6 is a flowchart of the operation of the electric brake system according to one embodiment.

### DETAILED DESCRIPTION

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc., are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

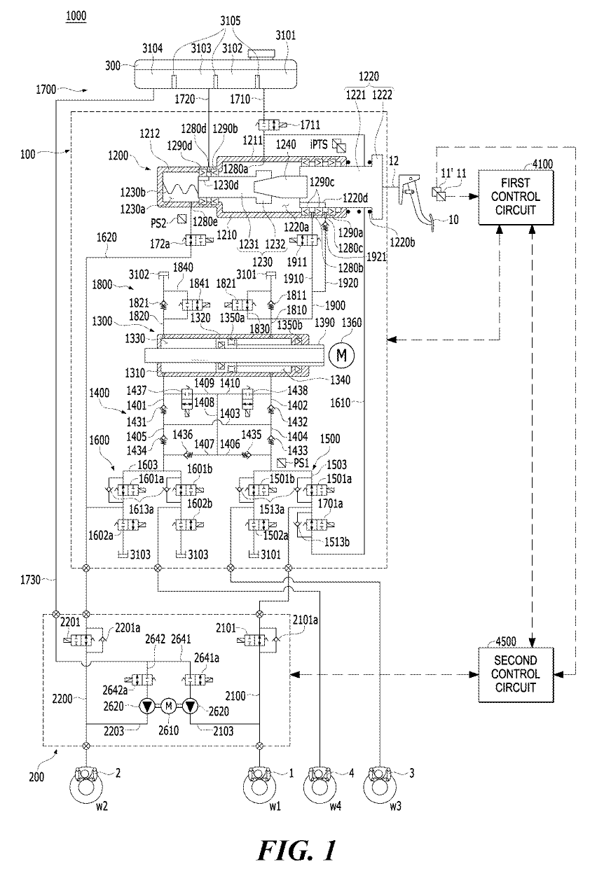

FIG. 1 is a hydraulic pressure circuit diagram illustrating an electric brake system according to one embodiment.

Referring to FIG. 1, an electric brake system 1000 may include a main brake module 100 (also referred to as a main brake 100; in some embodiments, it may be also referred to as an integrated dynamic brake (IDB) module or integrated dynamic brake) operated and controlled mechanically and/or electrically, an auxiliary brake module 200 (also referred to as “an auxiliary brake 200”) that is provided between the main brake module 100 and a plurality of wheel cylinders 1, 2, 3, and 4 and operates when the main brake module 100 is inoperable, a reservoir 300 in which a pressing medium is stored, a first control circuit 4100 for controlling the main brake module 100, and a second control circuit 4500 for controlling the auxiliary brake module 200.

The main brake module 100 may include an integrated master cylinder 1200 for providing a reaction force according to a pedal effort of a brake pedal 10 to a driver and, at the same time, pressing and discharging the pressing medium accommodated therein, a hydraulic pressure supply device 1300 for receiving the braking intention of the driver as an electrical signal from a first pedal displacement sensor 11 for detecting the displacement of the brake pedal 10 and generating a hydraulic pressure of the pressing medium through a mechanical operation, a hydraulic pressure control unit 1400 for controlling the hydraulic pressure provided from the hydraulic pressure supply device 1300, reservoir flow paths 1710, 1720, and 1730 that hydraulically connect the reservoir 300 to the integrated master cylinder 1200 and hydraulically connect the reservoir 300 to the auxiliary brake module 200, a dump control unit 1800 provided between the hydraulic pressure supply device 1300 and the reservoir 300 to control a flow of the pressing medium, and an inspection flow path 1900 provided to connect the integrated master cylinder 1200 to the hydraulic pressure supply device 1300 to inspect whether leakage occurs in various components.

When the driver steps on the brake pedal 10 for a braking operation, the integrated master cylinder 1200 is provided to provide a reaction force thereto to provide a stable pedal feel to the driver and, at the same time, press and discharge the pressing medium received therein by the operation of the brake pedal 10.

In the integrated master cylinder 1200, a master cylinder for pressing and discharging the pressing medium accommodated therein by the pedal effort of the brake pedal 10 and a pedal simulator 1240 for providing a pedal feel to the driver may be disposed coaxially within one cylinder body 1210.

The mastery cylinder of the integrated master cylinder 1200 may include the cylinder body 1210 forming a chamber therein, a first master chamber 1220a formed at an inlet of the cylinder body 1210 to which the brake pedal 10 is connected, a first master piston 122 provided in the first master chamber 1220a, connected to the brake pedal 10, and provided to be displaced by the operation of the brake pedal 10, a second master chamber 1230a formed an inner side than or in front of (left side based on FIG. 1) the first master chamber 1220a, and a second master piston 123 provided in the second master chamber 1230a and provided to be displaced by the displacement of the first master piston 1220 or a hydraulic pressure of the pressing medium accommodated in the first master chamber 1220a.

The pedal simulator 1240 may be disposed between the first master piston 1220 and the second master piston 1230 to provide a pedal feel through an elastic restoring force generated upon compression.

The first master chamber 1220a and the second master chamber 1230a may be formed sequentially inward (left side based on FIG. 1) from the brake pedal 10 (right side based on FIG. 1) on the cylinder body 1210 of the integrated master cylinder 1200. In addition, the first master piston 1220 and the second master piston 1230 are provided in the first master chamber 1220a and the second master chamber 1230a, respectively, to generate a hydraulic pressure or a negative pressure in the pressing medium accommodated in each chamber according to the forward movement and the backward movement.

The cylinder body 1210 may include a large diameter portion 1211 having the first master chamber 1220a formed therein and having a relatively large inner diameter, and a small diameter portion 1212 having the second master chamber 1230a formed therein and having a relatively smaller inner diameter than the large diameter portion 1211. The large diameter portion 1211 and the small diameter portion 1212 of the cylinder body 1210 may be formed integrally.

The first master chamber 1220a may be formed inside the large diameter portion 1211 that is formed in the front or rear (right side based on FIG. 1) of the cylinder body 1210, and the first master piston 1220 connected to the brake pedal 10 via an input rod 12 may be accommodated in the first master chamber 1220a to reciprocate.

The pressing medium may be introduced into and discharged from the first master chamber 1220a through a first hydraulic pressure port 1280a, a second hydraulic pressure port 1280b, and a third hydraulic pressure port 1280c.

The first hydraulic pressure port 1280a may be connected to the first reservoir flow path 1710 so that the pressing medium flows into the first master chamber 1220a from the reservoir 300 or the pressing medium accommodated in the first master chamber 1220a is discharged to the reservoir 300.

Through the second hydraulic pressure port 1280b and the third hydraulic pressure port 1280c, the first master chamber 1220a may be connected to first and second branch flow paths 1910 and 1920 of an inspection flow path 1900 to be described below, respectively, so that the pressing medium accommodated in the first master chamber 1220a is discharged toward the inspection flow path 1900 or the pressing medium is introduced into the first master chamber 1220a from the inspection flow path 1900.

The first master piston 1220 of the integrated master cylinder 1200 may be provided to be accommodated in the first master chamber 1220a and move forward (leftward based on FIG. 1) to press the pressing medium accommodated in the first master chamber 1220a to generate a hydraulic pressure or move backward (rightward based on FIG. 1) to generate a negative pressure inside the first master chamber 1220a. The first master piston 1220 may include a first body 1221 formed in a cylindrical shape to be in close contact with an inner circumferential surface of the first master chamber 1220a, and a first flange 1222 which is formed to radially extend at a rear end (right end portion based on FIG. 1) of the first body 1221 and to which the input rod 12 is connected. The first master piston 1220 may be elastically supported by a first piston spring 1220b, and the first piston spring 1220b may be provided to have one end supported by a front surface (left side based on FIG. 1) of the first flange 1222 and the other end supported by an outer surface of the cylinder body 1210.

The first master piston 1220 is provided with a first cut-off hole 1220d that communicates with the first master chamber 1220a and at the same time communicates with the third hydraulic pressure port 1280c in a non-operating state, that is, in a ready state before displacement occurs. In addition, a first sealing member 1290a for sealing the first master chamber 1220a from the outside may be provided between an outer circumferential surface of the first master piston 1220 and the cylinder body 1210. The first sealing member 1290a may be provided to be seated in an accommodating groove recessed in an inner circumferential surface of the cylinder body 1210, may be in contact with the outer circumferential surface of the first master piston 1220, can prevent the pressing medium accommodated in the first master chamber 1220a by the first sealing member 1290a from leaking externally, and at the same time prevent external foreign substances from flowing into the first master chamber 1220a. The first sealing member 1290a may be provided at an outermost side on the inner circumferential surface of the cylinder body 1210, that is, at the rear (right side based on FIG. 1) of the third hydraulic pressure port 1280c.

Third sealing members 1290c that block a flow of the pressing medium from flowing into the first master chamber 1220a from the first branch flow path 1910 connected to the third hydraulic pressure port 1280c may be provided between the outer circumferential surface of the first master piston 1220 and the cylinder body 1210. The third sealing members 1290c may each be seated in accommodating grooves formed in the front of the third hydraulic pressure port 1280c on the inner circumferential surface of the cylinder body 1210 to be in contact with the outer circumferential surface of the first master piston 1220. The third sealing member 1290c may be provided in front (left side based on FIG. 1) of the first sealing member 1290a and may allow the pressing medium accommodated in the first master chamber 1220a to flow to the first branch flow path 1910 through the third hydraulic pressure port 1280c but block a flow of the pressing medium from flowing into the first master chamber 1220a from the first branch flow path 1910.

The second master chamber 1230a may be formed inside the small diameter portion 1212 that is formed inside or in front (left side based on FIG. 1) of the cylinder body 1210, and the second master piston 1230 may be accommodated in the second master chamber 1230a to reciprocate.

The pressing medium may be introduced into and discharged from the second master chamber 1230a through a fourth hydraulic pressure port 1280d and a fifth hydraulic pressure port 1280e. The fourth hydraulic pressure port 1280d may be connected to the second reservoir flow path 1720 so that the pressing medium accommodated in the reservoir 300 flows into the second master chamber 1230a. In addition, the fifth hydraulic pressure port 1280e may be connected to a second connection flow path 1620 to be described below so that the pressing medium accommodated in the second master chamber 1230a is discharged toward the second connection flow path 1620, and conversely, the pressing medium flows into the second master chamber 1230a from the second connection flow path 1620.

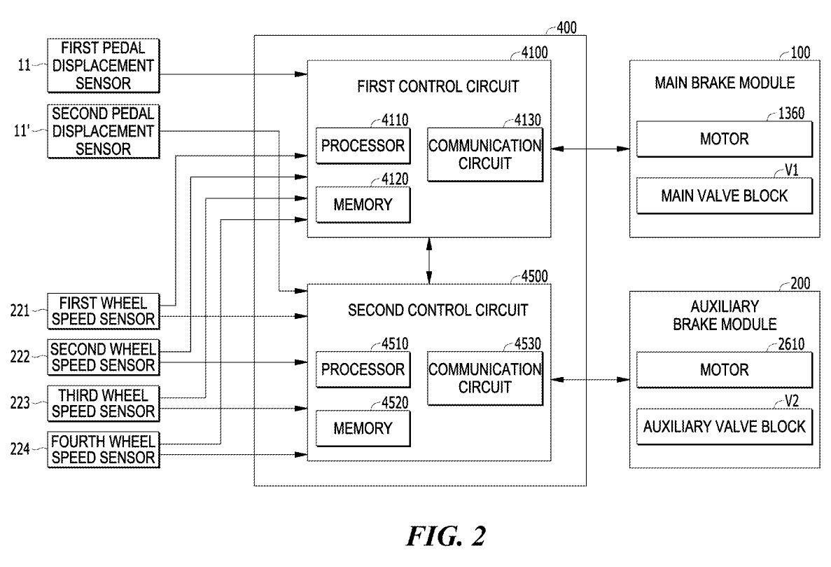

The second master piston 1230 may be provided to be accommodated in the second master chamber 1230a, move forward to generate a hydraulic pressure of the pressing medium accommodated in the second master chamber 1230a, and move backward to generate a negative pressure in the second master chamber 1230a. The second master piston 1230 may include a second body 1231 formed in a cylindrical shape to be in close contact with an inner circumferential surface of the second master chamber 1230a, and a second flange 1232 formed to radially extend at a rear end (right end portion based on FIG. 2) of the second body 1231 and disposed inside the first master chamber 1220a. A diameter of the second flange 1232 may be formed to be greater than an inner circumferential diameter of the second master chamber 1230a. The second master piston 1230 may be elastically supported by a second piston spring (not illustrated), and the second piston spring may be provided to have one end supported by a front surface (left surface based on FIG. 2) of the second body 1231 and the other end supported by an inner surface of the cylinder body 1210.

A second sealing member 1290b that seals the first master chamber 1220a with respect to the second master chamber 1230a may be provided between an outer circumferential surface of the second master piston 1230 and the cylinder body 1210. The second sealing member 1290b may be provided to be seated in an accommodating groove recessed in the inner circumferential surface of the cylinder body 1210 to be in contact with the outer circumferential surface of the second master piston 1230 and can prevent leakage of the pressing medium accommodated in the first master chamber 1220a by the second sealing member 1290b.

The second master piston 1230 is provided with a second cut-off hole 1230d that communicates with the second master chamber 1230a and at the same time communicates with the fourth hydraulic pressure port 1280d and the second reservoir flow path 1720 in a non-operating state, that is, in a ready state before displacement occurs. In addition, a fourth sealing member 1290d that blocks the pressing medium discharged from the second master chamber 1230a from flowing to the second reservoir flow path 1720 connected to the fourth hydraulic pressure port 1280d may be provided between the outer circumferential surface of the second master piston 1230 and the cylinder body 1210. The fourth sealing member 1290d may be seated in an accommodating groove recessed in the front (left side based on FIG. 1) of the fourth hydraulic pressure port 1280d on the inner circumferential surface of the cylinder body 1210 to be in contact with the outer circumferential surface of the second master piston 1230. The fourth sealing member 1290d may be provided in front of the second sealing member 1290b (left side based on FIG. 1) and may allow the pressing medium flowing to flow into the second master chamber 1230a from the second reservoir flow path 1720 connected to the fourth hydraulic pressure port 1280d but block the pressing medium discharged from the second master chamber 1230a from flowing to the fourth hydraulic pressure port 1280d and the second reservoir flow path 1720.

The integrated master cylinder 1200 can secure safety when a component fails by independently providing the first master chamber 1220a and the second master chamber 1230a. For example, the first master chamber 1220a may be connected to the wheel cylinders 1, 2, 3, and 4 through the inspection flow path 1900, the hydraulic pressure supply device 1300, the hydraulic pressure control unit 1400, and/or the auxiliary brake module 200, and the second master chamber 1230a may be connected to two wheel cylinders 1 and 2 through the second connection flow path 1620 to be described below, and thus the vehicle may be braked even when a problem such as leakage occurs in one chamber.

The pedal simulator 1240 may be provided between the first master piston 1220 and the second master piston 1230 and provide the pedal feel of the brake pedal 10 to the driver by the elastic restoring force thereof.

The pedal simulator 1240 may be interposed between a front surface of the first master piston 1220 and a rear surface of the second master piston 1230 and formed of an elastic material such as compressible and expandable rubber. The pedal simulator 1240 may include a cylindrical body portion at least partially inserted into and supported by the front surface of the first master piston 1220, and a tapered portion at least partially inserted into and supported by a rear surface of the second master piston 1230 and having a diameter gradually decreasing forward (left side based on FIG. 1). At least parts of both ends of the pedal simulator 1240 may each be stably supported by being inserted into the first master piston 1220. Furthermore, a stable and familiar pedal feel may be provided to the driver by changing the elastic restoring force according to the degree of a pedal effort of the brake pedal 10 by the tapered portion.

The hydraulic pressure supply device 1300 is provided to receive the braking intention of the driver as an electrical signal from the first pedal displacement sensor 11 for detecting the displacement of the brake pedal 10 and generating the hydraulic pressure of the pressing medium through a mechanical operation.

The hydraulic pressure supply device 1300 may include a hydraulic pressure provision unit for providing pressures of the pressing media transmitted to the wheel cylinders 1, 2, 3, and 4, a motor 1360 for generating a rotational force by an electrical signal of the first pedal displacement sensor 11, and a power conversion unit (not illustrated) for converting a rotational motion into a linear motion of the motor 1360 and transmitting the linear motion to the hydraulic pressure provision unit.

The hydraulic pressure provision unit of the hydraulic pressure supply device 1300 includes a cylinder block 1310 in which the pressing medium is provided to be accommodatable, a hydraulic piston 1320 accommodated in the cylinder block 1310, pressure chambers 1330 and 1340 of which volumes are changed by the operation of the hydraulic piston 1320, and a driving shaft 1390 for transmitting power output from the power conversion unit to the hydraulic piston 1320.

The first pressure chamber 1330 may be provided at a front surface side (a left direction of the hydraulic piston 1320 based on FIG. 1) of the hydraulic piston 1320. The second pressure chamber 1340 may be provided at a rear surface side (a right direction of the hydraulic piston 1320 based on FIG. 2) of the hydraulic piston 1320. That is, the first pressure chamber 1330 may be partitioned by the cylinder block 1310 and a front surface of the hydraulic piston 1320 and provided to have a volume that varies depending on the forward and backward movement of the hydraulic piston 1320. The second pressure chamber 1340 may be partitioned by the cylinder block 1310 and a rear surface of the hydraulic piston 1320 and provided to have a volume that varies depending on the forward and backward movement of the hydraulic piston 1320. The first pressure chamber 1330 is connected to the first hydraulic pressure flow path 1401, which will be described below, through a communication hole formed in the cylinder block 1310, and the second pressure chamber 1340 is connected to the second hydraulic pressure flow path 1402 described below through a communication hole formed in the cylinder block 1310.

A sealing member may be provided between the hydraulic piston 1320 and the cylinder block 1310 to seal openings of the first and second pressure chambers 1330 and 1340 and the cylinder block 1310 so that the hydraulic pressures or negative pressures of the first and second pressure chambers 1330 and 1340 generated by the forward or backward movement of the hydraulic piston 1320 do not leak to the outside and may be transmitted to the hydraulic pressure control unit 1400 and the dump control unit 1800, which will be described below.

The motor 1360 is provided to generate a driving force of the hydraulic piston 1320 by an electric signal output from the first control circuit 4100. The motor 1360 may be provided with a stator and a rotor and thus rotate in a forward direction or a reverse direction to provide power for generating the displacement of the hydraulic piston 1320. A rotational angular speed and rotational angle of the motor 1360 may be precisely controlled by a motor control sensor (not illustrated). Since the motor 1360 is a well-known technology, detailed description thereof will be omitted.

The power conversion unit of the hydraulic pressure supply device 1300 is provided to convert the rotational force of the motor 1360 into a linear motion. For example, the power conversion unit may be provided in a structure including a worm shaft (not illustrated), a worm wheel (not illustrated), and a driving shaft 1390.

The worm shaft may be formed integrally with a rotational shaft of the motor 1360, and a worm may be formed on an outer circumferential surface of the worm shaft and coupled to be engaged with the worm wheel to rotate the worm wheel. The worm wheel may be connected to be engaged with the driving shaft 1390 to linearly move the driving shaft 1390, and the driving shaft 1390 may be connected to the hydraulic piston 1320 to operates integrally, and thus the hydraulic piston 1320 may slide in the cylinder block 1310.

Describing the above operations again, when the displacement of the brake pedal 10 is detected by the first pedal displacement sensor 11, the detected signal is transmitted to the first control circuit 4100, and the first control circuit 4100 drives the motor 1360 to rotate the worm shaft in one direction. The rotational force of the worm shaft may be transmitted to the driving shaft 1390 through the worm wheel, and the hydraulic piston 1320 connected to the driving shaft 1390 may move forward in the cylinder block 1310 to generate a hydraulic pressure in the pressure chamber 1330.

Conversely, when the pedal effort of the brake pedal 10 is released, the first control circuit 4100 drives the motor 1360 to rotate the worm shaft in an opposite direction. Accordingly, the worm wheel may also rotate in the opposite direction, and the hydraulic piston 1320 connected to the driving shaft 1390 may move backward in the cylinder block 1310 to generate a negative pressure in the pressure chamber 1330.

The hydraulic pressure supply device 1300 may be hydraulically connected to the reservoir 300 by the dump control unit 1800.

The hydraulic pressure control unit 1400 may be provided to control the flows of the pressing media toward each of the wheel cylinders 1, 2, 3, and 4 or the flow of the pressing medium collected in the hydraulic pressure supply device 1300 from each of the wheel cylinders 1, 2, 3, and 4. To this end, the hydraulic pressure control unit 1400 may include a plurality of flow paths and a plurality of valves capable of allowing or blocking the flow of the pressing medium in the plurality of flow paths to smoothly control the flow or hydraulic pressure of the pressing medium. In addition, the hydraulic pressure control unit 1400 may include first and second hydraulic pressure circuits 1500 and 1600 for controlling the flows of the hydraulic pressures transmitted to the wheel cylinders 1, 2, 3, and 4 that perform braking of wheels w1, w2, w3, and w4 by the received hydraulic pressure of the pressing medium.

The hydraulic pressure control unit 1400 may include first to tenth hydraulic pressure flow paths 1401, 1402, 1403, 1404, 1405, 1406, 1407, 1408, 1409, and 1410. The first hydraulic pressure flow path 1401 may be provided to communicate with the first pressure chamber 1330, and the second hydraulic pressure flow path 1402 may be provided to communicate with the second pressure chamber 1340.

The first hydraulic pressure flow path 1401 and the second hydraulic pressure flow path 1402 may be provided to be merged with a third hydraulic pressure flow path 1403 and then re-branched into a fourth hydraulic pressure flow path 1404 connected to the first hydraulic pressure circuit 1500, and a fifth hydraulic pressure flow path 1405 connected to the second hydraulic pressure circuit 1600.

The sixth hydraulic pressure flow path 1406 may be provided to communicate with the first hydraulic pressure circuit 1500, and the seventh hydraulic pressure flow path 1407 may be provided to communicate with the second hydraulic pressure circuit 1600. The sixth hydraulic pressure flow path 1406 and the seventh hydraulic pressure flow path 1407 may be merged with the eighth hydraulic pressure flow path 1408 and then re-branched into the ninth hydraulic pressure flow path 1409 that communicates with the first pressure chamber 1330 and the tenth hydraulic pressure flow path 1410 that communicates with the second pressure chamber 1340.

The first hydraulic pressure flow path 1401 may be provided with a first valve 1431 that controls the flow of the pressing medium. The first valve 1431 may be provided as a check valve that allows the flow of the pressing medium discharged from the first pressure chamber 1330 but blocks the pressing medium from flowing in the opposite direction. In addition, the second hydraulic pressure flow path 1402 may be provided with a second valve 1432 that controls the flow of the pressing medium, and the second valve 1432 may be provided as a check valve that allows the flow of the pressing medium discharged from the second pressure chamber 1340 and blocks the pressing medium from flowing in the opposite direction.

The fourth hydraulic pressure flow path 1404 is provided to be branched from the third hydraulic pressure flow path 1403, at which the first hydraulic pressure flow path 1401 and the second hydraulic pressure flow path 1402 are merged, and connected to the first hydraulic pressure circuit 1510. The third hydraulic pressure flow path 1403 may be provided with a third valve 1433 that controls the flow of the pressing medium. The third valve 1433 may be provided as a check valve that allows the pressing medium to flow only from the third hydraulic pressure flow path 1403 to the first hydraulic pressure circuit 1500 and blocks the pressing medium from flowing in the opposite direction.

The fifth hydraulic pressure flow path 1405 is provided to be branched from the third hydraulic pressure flow path 1403, at which the first hydraulic pressure flow path 1401 and the second hydraulic pressure flow path 1402 are merged, and connected to the second hydraulic pressure circuit 1600. The fifth hydraulic pressure flow path 1405 may be provided with a fourth valve 1434 that controls the flow of the pressing medium. The fourth valve 1434 may be provided as a check valve that allows the pressing medium to flow only from the third hydraulic pressure flow path 1403 to the second hydraulic pressure circuit 1600 and blocks the pressing medium from flowing in the opposite direction.

The sixth hydraulic pressure flow path 1406 is provided to communicate with the first hydraulic pressure circuit 1500, and the seventh hydraulic pressure flow path 1407 is provided to communicate with the second hydraulic pressure circuit 1600 and to be merged with the eighth hydraulic pressure flow path 1408. The sixth hydraulic pressure flow path 1406 may be provided with a fifth valve 1435 that controls the flow of the pressing medium. The fifth valve 1435 may be provided as a check valve that allows the flow of the pressing medium discharged from the first hydraulic pressure circuit 1500 but blocks the pressing medium from flowing in the opposite direction. In addition, the seventh hydraulic pressure flow path 1407 may be provided with a sixth valve 1436 that controls the flow of the pressing medium. The sixth valve 1436 may be provided as a check valve that allows only the flow of the pressing medium discharged from the second hydraulic pressure circuit 1600 and blocks the pressing medium from flowing in the opposite direction.

The ninth hydraulic pressure flow path 1409 is provided to be branched from the eighth hydraulic pressure flow path 1408, at which the sixth hydraulic pressure flow path 1406 and the seventh hydraulic pressure flow path 1407 are merged, and connected to the first pressure chamber 1330. The ninth hydraulic pressure flow path 1409 may be provided with a seventh valve 1437 that controls the flow of the pressing medium. The seventh valve 1437 may be provided as a two-way control valve that controls the flow of the pressing medium transmitted along the ninth hydraulic pressure flow path 1409. The seventh valve 1437 may be provided as a normal closed type solenoid valve.

The tenth hydraulic pressure flow path 1410 is provided to be branched from the eighth hydraulic pressure flow path 1408, at which the sixth hydraulic pressure flow path 1406 and the seventh hydraulic pressure flow path 1407 are merged, and connected to the second pressure chamber 1340. The tenth hydraulic pressure flow path 1410 may be provided with an eighth valve 1438 that controls the flow of the pressing medium. The eighth valve 1438 may be provided as a bidirectional control valve that controls the flow of the pressing medium transmitted along the tenth hydraulic pressure flow path 1410. The eighth valve 1438 may be provided as a normal closed type solenoid valve.

According to the above-described plurality of hydraulic pressure flow paths and plurality of valves, the hydraulic pressure generated in the first pressure chamber 1330 by the forward movement of the hydraulic piston 1320 may be transmitted to the first hydraulic pressure circuit 1500 sequentially through the first hydraulic pressure flow path 1401, the third hydraulic pressure flow path 1403, and the fourth hydraulic pressure flow path 1404 and may be transmitted to the second hydraulic pressure circuit 1600 sequentially through the first hydraulic pressure flow path 1401 and the fifth hydraulic pressure flow path 1405. In addition, the hydraulic pressure generated in the second pressure chamber 1340 by the backward movement of the hydraulic piston 1320 may be transmitted to the first hydraulic pressure circuit 1500 sequentially through the second hydraulic pressure flow path 1402 and the fourth hydraulic pressure flow path 1404 and may be transmitted to the second hydraulic pressure circuit 1600 sequentially through the second hydraulic pressure flow path 1402, the third hydraulic pressure flow path 1403, and the fifth hydraulic pressure flow path 1405.

Conversely, the negative pressure generated in the first pressure chamber 1330 by the backward movement of the hydraulic piston 1320 may cause the pressing medium provided to the first hydraulic pressure circuit 1510 to be collected in the first pressure chamber 1330 sequentially through the sixth hydraulic pressure flow path 1406, the eighth hydraulic pressure flow path 1408, and the ninth hydraulic pressure flow path 1409, and cause the pressing medium provided to the second hydraulic pressure circuit 1600 to be collected in the first pressure chamber 1330 sequentially through the seventh hydraulic pressure flow path 1407, the eighth hydraulic pressure flow path 1408, and the ninth hydraulic pressure flow path 1409. In addition, the negative pressure generated in the second pressure chamber 1340 by the forward movement of the hydraulic piston 1320 may cause the pressing medium provided to the first hydraulic pressure circuit 1500 to be collected in the first pressure chamber 1340 sequentially through the sixth hydraulic pressure flow path 1406, the eighth hydraulic pressure flow path 1408, and the tenth hydraulic pressure flow path 1410, and the pressing medium provided to the second hydraulic pressure circuit 1600 to be collected in the second pressure chamber 1340 sequentially through the seventh hydraulic pressure flow path 1407, the eighth hydraulic pressure flow path 1408, and the tenth hydraulic pressure flow path 1410.

The first hydraulic pressure circuit 1500 may adjust and control the hydraulic pressures applied to the first and third wheel cylinders 1 and 3, and the second hydraulic pressure circuit 1600 may adjust and control the hydraulic pressures applied to the second and fourth wheel cylinders 2 and 4.

The first hydraulic pressure circuit 1500 may include a first inlet valve 1501a disposed at an upstream side of the first wheel cylinder 1 to control the flow and hydraulic pressure of the pressing medium delivered to the first wheel cylinder 1, and a third inlet valve 1501b disposed at an upstream side of the third wheel cylinder 3 to control the flow and hydraulic pressure of the pressing medium transmitted to the third wheel cylinder 3. The first and third inlet valves 1501a and 1501b may be normal open type solenoid valves.

In addition, the first hydraulic pressure circuit 1500 may include first and third outlet valves 1701a and 1502a that control the flows of the pressing media discharged from the first and third wheel cylinders 1 and 3 to improve performance when the braking of the first and third wheel cylinders 1 and 3 is released.

The first outlet valve 1701a may be connected (or provided) to a first connection flow path 1610, which will be described below, corresponding to an outlet of the first wheel cylinder 1 to control the pressing medium to flow between the first wheel cylinder 1 and the integrated master cylinder 1200. For example, the first outlet valve 1701a may be provided as a normal open type solenoid valve.

The third outlet valve 1502a may be provided at the outlet of the third wheel cylinder 3 to control the pressing medium transmitted from the third wheel cylinder 3 to flow to the reservoir 300, more specifically, to flow to the first reservoir chamber 3101 of the reservoir 300. For example, the third outlet valve 1502a may be provided as a normal closed type solenoid valve.

The first hydraulic pressure circuit 1500 may include a check valve 1513a connected parallel to each of the first inlet valve 1501a and the third inlet valve 1501b. In addition, the first hydraulic pressure circuit 1500 may include a check valve 1513b connected parallel to the first outlet valve 1701a.

The check valve 1513a of the first inlet valve 1501a may be provided on a bypass flow path that connects the front and rear of the first inlet valve 1501a and may allow the pressing medium to flow only from the first wheel cylinder 1 to the hydraulic pressure supply device 1300 and block the pressing medium from flowing from the hydraulic pressure supply device 1300 to the first wheel cylinder 1.

The check valve 1513a of the third inlet valve 1501b may be provided on a bypass flow path that connects the front and rear of the third inlet valve 1501b and may allow the pressing medium to flow only from the third wheel cylinder 3 to the hydraulic pressure supply device 1300 and block the pressing medium from flowing from the hydraulic pressure supply device 1300 to the third wheel cylinder 3.

The check valve 1513b of the first outlet valve 1701a may be provided on a bypass path that connects the front and rear of the first outlet valve 1701a.

The first inlet valve 1501a, the third inlet valve 1501b, the first outlet valve 1701a, and the third outlet valve 1502a of the first hydraulic pressure circuit 1500 may be provided on a first hydraulic pressure circuit flow path 1503.

The first hydraulic pressure circuit flow path 1503 may be connected to or extends from the first connection flow path 1610. The flow hydraulic pressure circuit flow path 1503 may be merged with the fourth hydraulic pressure flow path 1404 of the hydraulic pressure control unit 1400 at the upstream sides of the first inlet valve 1501a and the third inlet valve 1501b. The first hydraulic pressure circuit flow path 1503 may be connected to the first connection flow path 1610 connected to a downstream of the first outlet valve 1701a through the first outlet valve 1701a. The first hydraulic pressure circuit flow path 1503 may be branched at the downstream of the first inlet valve 1501a and the upstream side of the first outlet valve 1701a and connected to the first wheel cylinder 1. The first hydraulic pressure circuit flow path 1503 may be branched at the downstream of the third inlet valve 1501b and the upstream side of the third outlet valve 1502a and connected to the third wheel cylinder 3.

The second hydraulic pressure circuit 1600 may include a second inlet valve 1601a disposed at an upstream side of the second wheel cylinder 2 to control the flow and hydraulic pressure of the pressing medium delivered to the second wheel cylinder 2, and a fourth inlet valve 1601b disposed at an upstream side of the fourth wheel cylinder 4 to control the flow and hydraulic pressure of the pressing medium transmitted to the fourth wheel cylinder 4. The second and fourth inlet valves 1601a and 1601b may be normal open type solenoid valves.

The second hydraulic pressure circuit 1600 may include second and fourth outlet valves 1602a and 1602b that control the flows of the pressing media discharged from the second and fourth wheel cylinders 2 and 4 to improve performance when the braking of the second and fourth wheel cylinders 2 and 4 is released.

The second outlet valve 1602a may be provided at an outlet of the second wheel cylinder 2 to control the pressing medium transmitted from the second wheel cylinder 2 to flow to the reservoir 300, more specifically, to the third reservoir chamber 3103 of the reservoir 300. For example, the second outlet valve 1602a may be provided as a normal closed type solenoid valve.

The fourth outlet valve 1602b may be provided at an outlet of the fourth wheel cylinder 4 to control the pressing medium transmitted from the fourth wheel cylinder 4 to flow to the reservoir 300, more specifically, to the third reservoir chamber 3103 of the reservoir 300. For example, the fourth outlet valve 1602b may be provided as a normal closed type solenoid valve.

The second hydraulic pressure circuit 1600 may include a check valve 1613a connected parallel to each of the second inlet valve 1601a and the fourth inlet valve 1601b.

The check valve 1613a of the second inlet valve 1601a may be provided on a bypass flow path that connects the front and rear of the second inlet valve 1601a and may allow the pressing medium to flow only from the second wheel cylinder 2 to the hydraulic pressure supply device 1300 and block the pressing medium from flowing from the hydraulic pressure supply device 1300 to the second wheel cylinder 2.

The check valve 1613a of the fourth inlet valve 1601b may be provided on a bypass flow path that connects the front and rear of the fourth inlet valve 1601b and may allow the pressing medium to flow only from the fourth wheel cylinder 4 to the hydraulic pressure supply device 1300 and block the pressing medium from flowing from the hydraulic pressure supply device 1300 to the fourth wheel cylinder 4.

The second inlet valve 1601a, the fourth inlet valve 1601b, the second outlet valve 1602a, and the fourth outlet valve 1602b may be provided on the second hydraulic pressure circuit flow path 1603.

The second hydraulic pressure circuit flow path 1603 may be branched from the second connection flow path 1620 or connected to the second connection flow path 1620. The second hydraulic pressure circuit flow path 1603 may be branched at the downstream of the second inlet valve 1601a and the upstream side of the second outlet valve 1602a and connected to the second wheel cylinder 2. The second hydraulic pressure circuit flow path 1603 may be merged with the fifth hydraulic pressure flow path 1405 of the hydraulic pressure control unit 1400 at the upstream sides of the second inlet valve 1601a and the fourth inlet valve 1601b. The second hydraulic pressure circuit flow path 1603 may be branched between the fourth inlet valve 1601b and the fourth outlet valve 1602b and connected to the fourth wheel cylinder 4.

The first connection flow path 1610 of the main brake module 100 may be provided to connect the first master chamber 1220a of the integrated master cylinder 1200 to the first hydraulic pressure circuit 1500, and the second connection flow path 1620 may be provided to connect the second master chamber 1230a of the integrated master cylinder 1200 to the second hydraulic pressure circuit 1600.

The first connection flow path 1610 may be provided to connect an outlet of the simulator valve 1711 provided on the first reservoir flow path 1710, which will be described below, to the first wheel cylinder 1. For example, the first connection flow path 1610 may communicate with the first wheel cylinder 1 through the first outlet valve 1701a and the auxiliary brake module 200 so that the outlet of the simulator valve 1711 provided on the first reservoir flow path 1710 and the first wheel cylinder 1 are connected.

The second connection flow path 1620 may be provided to connect the fifth hydraulic pressure port 1280e to the second wheel cylinder 2. For example, the second connection flow path 1620 may communicate with the second wheel cylinder 2 through the auxiliary brake module 200 so that the fifth hydraulic pressure port 1280e and the second wheel cylinder 2 are connected.

A cut valve 172a that controls a bidirectional flow of the pressing medium may be provided on the second connection flow path 1620. For example, the cut valve 172a may be provided as a normal open type solenoid valve.

The reservoir flow path 1700 may be provided to connect the integrated master cylinder 1200 to the reservoir 300.

The reservoir flow path 1700 may include the first reservoir flow path 1710 that connects the first master chamber 1220a to the first reservoir chamber 3101 of the reservoir 300, the second reservoir flow path 1720 that connects the second master chamber 1230a to the third reservoir chamber 3103 of the reservoir 300. In addition, the reservoir flow path 1700 may include the third reservoir flow path 1730 that connects the auxiliary brake module 200 to the fourth reservoir chamber 3104 of the reservoir 300.

One end of the first reservoir flow path 1710 may communicate with the first master chamber 1220a by the first hydraulic pressure port 1280a of the integrated master cylinder 1200, and the other end may communicate with the first reservoir chamber 3101 of the reservoir 300. The simulator valve 1711 may be provided on the first reservoir flow path 1710, and thus the flow of the pressing medium between the reservoir 300 and the first master chamber 1220a through the first reservoir flow path 1710 may be controlled.

One end of the second reservoir flow path 1720 may communicate with the second master chamber 1230a by the fourth hydraulic pressure port 1280d of the integrated master cylinder 1200, and the other end may communicate with the reservoir 300.

One end of the third reservoir flow path 1730 may be connected to auxiliary supply flow paths 2641 and 2642 connected to a pair of pumps 2620, which will be described below, of the auxiliary brake module 200.

The dump control unit 1800 may include at least one flow path and at least one valve to control the pressing medium to flow between the hydraulic pressure supply device 1300 and the reservoir 300.

The dump control unit 1800 may include a first dump control unit that controls a pressing medium to flow between the second pressure chamber 1340 and the first reservoir chamber 3101 of the reservoir 300, and a second dump control unit that controls a pressing medium to flow between the first pressure chamber 1330 and the second reservoir chamber 3102 of the reservoir 300.

The first dump control unit may include a first dump flow path 1810 that connects the second pressure chamber 1340 to the reservoir 300, and a first bypass flow path 1830 branched from and then remerged with the first dump flow path 1810. The second dump control unit may include a second dump flow path 1820 that connects the first pressure chamber 1330 to the reservoir 300, and a second bypass flow path 1840 branched from and then remerged with the second dump flow path 1820.

A first dump check valve 1811 and a first dump valve 1831 that control the flow of the pressing medium may be provided on the first dump flow path 1810 and the first bypass flow path 1830, respectively. The first dump check valve 1811 may be provided to allow the pressing medium to flow only from the reservoir 300 to the first pressure chamber 1330 and block the pressing medium from flowing in an opposite direction. The first bypass flow path 1830 may be connected parallel to the first dump check valve 1811 on the first dump flow path 1810, and the first bypass flow path 1830 may be provided with the first dump valve 1831 that controls the pressing medium to flow between the first pressure chamber 1330 and the reservoir 300. That is, the first bypass flow path 1830 may be connected by bypassing a front end and a rear end of the first dump check valve 1811 on the first dump flow path 1810, and the first dump valve 1831 may be provided as a two-way solenoid valve that controls the pressing medium to flow between the first pressure chamber 1330 and the reservoir 300. The first dump valve 1831 may be provided as a normal open type solenoid valve.

A second dump check valve 1821 and a second dump valve 1841 that control the flow of the pressing medium may be provided on the second dump flow path 1820 and the second bypass flow path 1840, respectively. The second dump check valve 1821 may be provided to allow the pressing medium to flow only from the reservoir 300 to the first pressure chamber 1330 and block the pressing medium from flowing in an opposite direction. The second bypass flow path 1840 may be connected parallel to the second dump check valve 1821 on the second dump flow path 1820, and the second bypass flow path 1840 may be provided with the second dump valve 1841 that controls the pressing medium to flow between the first pressure chamber 1330 and the reservoir 300. That is, the second bypass flow path 1840 may be connected by bypassing a front end and a rear end of the second dump check valve 1821 on the second dump flow path 1820, and the second dump valve 1841 may be provided as a two-way solenoid valve that controls the pressing medium to flow between the first pressure chamber 1330 and the reservoir 300. The second dump valve 1841 may be provided as a normal closed type solenoid valve.

The inspection flow path 1900 is provided to connect the integrated master cylinder 1200 to the hydraulic pressure supply device 1300 and provided to inspect whether leakage occurs in various components mounted on the integrated master cylinder 1200 and the simulator valve 1711.

The inspection flow path 1900 may have one end connected to the second pressure chamber 1340 and the other end branched into the first branch flow path 1910 and the second branch flow path 1920 that are connected to the first master chamber 1220a through the second hydraulic pressure port 1280b and the third hydraulic pressure port 1280c, respectively.

For example, an inspection valve 1911 may be provided on the first branch flow path 1910 to control the pressing medium to bidirectionally flow between the first master chamber 1220a and the second pressure chamber 1340. A test check valve 1921 may be provided on the second branch flow path 1920 to allow the pressing medium to flow only from the first master chamber 1220a to the second pressure chamber 1340 and block the pressing medium from flowing in the opposite direction.

One end of the inspection flow path 1900 may be connected to the second pressure chamber 1340 via the first dump flow path 1810 as illustrated in FIG. 1 but may be directly connected to the second pressure chamber 1340, which differs from that in FIG. 1.

The main brake module 100 may further include a circuit pressure sensor PS1 for detecting the hydraulic pressure of the pressing medium provided by the hydraulic pressure supply device 1300 and a cylinder pressure sensor PS2 for detecting the hydraulic pressure of the second master chamber 1230a.

The circuit pressure sensor PS1 may be provided on the first hydraulic pressure circuit 1500 to detect the hydraulic pressure of the pressing medium generated and provided from the hydraulic pressure supply device 1300 and transmitted to the first hydraulic pressure circuit 1510 in the inspection mode. For example, the circuit pressure sensor PS1 may be provided on the fourth hydraulic pressure flow path 1404.

The cylinder pressure sensor PS2 may be provided between the second master chamber 1230a and the cut valve 172a on the second connection flow path 1620 to detect the hydraulic pressure of the pressing medium accommodated in the second master chamber 1230a. For example, a signal corresponding to pressure value information of the pressing medium detected by the circuit pressure sensor PS1 and the cylinder pressure sensor PS2 may be transmitted to the first control circuit 4100, and the first control circuit 4100 may compare a hydraulic pressure value detected by the circuit pressure sensor PS1 with a hydraulic pressure value detected by the cylinder pressure sensor PS2 and determine whether leakage occurs in the integrated master cylinder 1200 or the simulator valve 1711.

In addition, the main brake module 100 may further include a stroke sensor (not illustrated) for measuring the displacement of the hydraulic piston 1320 of the hydraulic pressure supply device 1300, and the stroke sensor may be used to inspect whether leakage occurs in the integrated master cylinder 1200 based on information on the displacement of the hydraulic piston 1320.

The auxiliary brake module 200 may operate upon receiving a braking request from an external controller while the main brake module 100 is inoperable and generate and provide the hydraulic pressure required for braking the first and second wheel cylinders 1 and 2.

The auxiliary brake module 200 may include a pair of pumps 2620 that presses a pressing medium, a motor 2610 for driving the pair of pumps 2620, a first auxiliary flow path 2103 for transmitting the pressing medium pressed by the pumps 2620 to the first wheel cylinder 1, a second auxiliary flow path 2203 for transmitting the pressing medium pressed by the pumps 2620 to the second wheel cylinder 2, a first auxiliary supply flow path 2641 and a second auxiliary supply flow path 2642 that are provided to supply the pressing medium to each of the pair of pumps 2620, a first auxiliary supply valve 2641a provided on the first auxiliary supply flow path 2641 to control the pressing medium to be supplied to the pump 2620, a second auxiliary supply valve 2641b provided on the second auxiliary supply flow path 2642 to control the pressing medium to be supplied to the pump 2620, a first auxiliary connection flow path 2100 hydraulically connected to the first connection flow path 1610, a second auxiliary connection flow path 2200 hydraulically connected to the second connection flow path 1620, a first pressure control valve 2101 provided in the first auxiliary connection flow path 2100 to adjust a pressure of the first auxiliary connection flow path 2100 and the first auxiliary supply flow path 2641, a second pressure control valve 2201 provided in the second auxiliary connection flow path 2200 to control a pressure of the second auxiliary connection flow path 2200 and the second auxiliary supply flow path 2642, a first check valve 2101a connected parallel to the first pressure control valve 2101, and a second check valve 2201a connected parallel to the second pressure control valve 2201.

The pair of pumps 2620 may press the pressing medium according to the reciprocating movement of a piston (not illustrated) provided in the motor 2610. The pump 2620 receives the pressing medium from the first auxiliary supply flow path 2641 hydraulically connected to the third reservoir flow path 1730 of the reservoir 300 and presses the pressing medium to the level of the hydraulic pressure required for braking by operating the motor 2610.

The pressing medium having the hydraulic pressure generated by one of the pair of pumps 2620 may be transmitted to the first wheel cylinder 1 by the first auxiliary flow path 2103 provided as an outlet flow path of the pump 2620. To this end, the first auxiliary flow path 2103 may have an inlet end portion connected to the outlet of the pump 2620 and an outlet end portion connected to the first wheel cylinder 1.

The pressing medium having the hydraulic pressure generated by the other of the pair of pumps 2620 may be transmitted to the second wheel cylinder 2 by the second auxiliary flow path 2203 provided as an outlet flow path of the pump 2620. To this end, the second auxiliary flow path 2203 may have an inlet end portion connected to the outlet of the pump 2620 and an outlet end portion connected to the second wheel cylinder 2.

The first auxiliary supply flow path 2641 may have one end portion connected to the inlet of the pump 2620 and connected to the first auxiliary flow path 2103. In addition, the other end portion of the first auxiliary supply flow path 2641 may be connected to the third reservoir flow path 1730.

The first auxiliary supply flow path 2641 is provided with a first auxiliary supply valve 2641a that controls the flow of the pressing medium supplied to the pump 2620. The first auxiliary supply valve 2641a may be provided as a normal closed type solenoid valve.

The second auxiliary supply flow path 2642 may have one end portion connected to the inlet of the pump 2620 and be connected to the second auxiliary flow path 2203. In addition, the other end portion of the second auxiliary supply flow path 2642 may be connected to the third reservoir flow path 1730. The other end portion of the second auxiliary supply flow path 2642 may be branched from the first auxiliary supply flow path 2641 or connected to the first auxiliary supply flow path 2641.

The second auxiliary supply flow path 2642 is provided with a second auxiliary supply valve 2642a that controls the flow of the pressing medium supplied to the pump 2620. The second auxiliary supply valve 2642a may be provided as a normal closed type solenoid valve.

The first auxiliary connection flow path 2100 may extend to the first connection flow path (1610) and may be referred to as a part of the first connection flow path 1610, that is, the first connection flow path 1610. In addition, the second auxiliary connection flow path 2200 may extend to the second connection flow path 1620 and may be referred to as a part of the second connection flow path 1620, that is, the second connection flow path 1620.

A first pressure control valve 2101 may be provided on the first auxiliary connection flow path 2100, and a second pressure control valve 2201 may be provided on the second auxiliary connection flow path 2200.

The first pressure control valve 2101 may adjust a blocking pressure according to an electrical signal (or a current) from the second control circuit 4500 to adjust a pressure of the first auxiliary connection flow path 2100 and the first auxiliary supply flow path 2103.

The second pressure control valve 2201 may adjust a blocking pressure according to an electrical signal (or a current) from the second control circuit 4500 to adjust a pressure of the second auxiliary connection flow path 2200 and the second auxiliary supply flow path 2203.

The first pressure control valve 2101 and the second pressure control valve 2201 may be normal open type solenoid valves.

The first check valve 2101a connected parallel to the first pressure control valve 2101 and the second check valve 2201a connected parallel to the second pressure control valve 2201 may allow the pressing medium to flow in one direction to prevent a backflow in an opposite direction and may be controlled according to an electrical signal from the second control circuit 4500.

The reservoir 300 may accommodate and store the pressing medium therein. The reservoir 300 may be hydraulically connected to at least one component of the main brake module 100 and at least one component of the auxiliary brake module 200.

The reservoir 300 may be provided by being partitioned into a plurality of chambers by bulkheads 3105.

The reservoir 300 may include a plurality of reservoir chambers 1101, 1102, 1103, and 1104, and the plurality of reservoir chambers 1101, 1102, 1103, and 1104 may be disposed in parallel in a row. For example, the first reservoir chamber 3101, the second reservoir chamber 3102, the third reservoir chamber 3103, and the fourth reservoir chamber 3104 may be disposed in parallel in a row from one side to the other side of the reservoir 300.

The first reservoir chamber 3101 may communicate with the first reservoir flow path 1710 and be connected to the integrated master cylinder 1200 and may supply the pressing medium to the first master chamber 1220a of the integrated master cylinder 1200 or receive the pressing medium from the first master chamber 1220a. In addition, the first reservoir chamber 3101 may be hydraulically connected to the dump control unit 1800 and the hydraulic pressure circuit 1510.

The second reservoir chamber 3102 may be hydraulically connected to the dump control unit 1800.

The third reservoir chamber 3103 may communicate with the second reservoir flow path 1720 and be connected to the integrated master cylinder 1200. For example, the third reservoir chamber 3103 may supply the pressing medium to the second master chamber 1230a of the integrated master cylinder 1200 or receive the pressing medium from the second master chamber 1230a through the second reservoir flow path 1720 and the fourth hydraulic pressure port 1280d of the integrated master cylinder 1200 connected to the second reservoir flow path 1720. In addition, the third reservoir chamber 3103 may be hydraulically connected to the second hydraulic pressure circuit 1600.

The fourth reservoir chamber 3104 may communicate with the third reservoir flow path 1730 and be connected to the auxiliary brake module 200. For example, the fourth reservoir chamber 3104 may be connected to upstream sides of the auxiliary supply valves 2641a and 2642a of the auxiliary brake module 200 through the third reservoir flow path 1730.

The bulkheads 3105 may each be provided between adjacent reservoir chambers. At least a part of an upper end of each bulkhead 3105 may be open, thereby allowing adjacent reservoir chambers 1101, 1102, 1103, and 1104 to communicate with each other to allow the pressing medium to move. For example, when a large amount of pressing medium flows into the first reservoir chamber 3101, the pressing medium may pass through the upper end of the bulkhead 3105be and may be transmitted to the second reservoir chamber 3102, the third reservoir chamber 3103, and/or the fourth reservoir chamber 3104.

In this way, since the reservoir 300 is provided by being partitioned into the first to fourth reservoir chambers 1101, 1102, 1103, and 1104, the stable operation of the electric brake system 1000 can be implemented. For example, when the reservoir 300 is formed as one chamber and the capacity of the pressing medium is insufficient, the pressing medium cannot be stably supplied not only to the hydraulic pressure supply device 1300, but also to the integrated master cylinder 1200 and the dump control unit 1800. Accordingly, by separately providing the reservoir 300, even when the pressing medium may not be supplied to one component, the braking of the vehicle can be implemented by supplying the pressing medium to another component.

The main brake module 100 may be electrically connected to the first control circuit 4100 and controlled by the first control circuit 4100.

The auxiliary brake module 200 may be electrically connected to the second control circuit 4500 and controlled by the second control circuit 4500.

FIG. 2 is a block diagram illustrating a configuration of a control circuit of the electric brake system according to one embodiment.

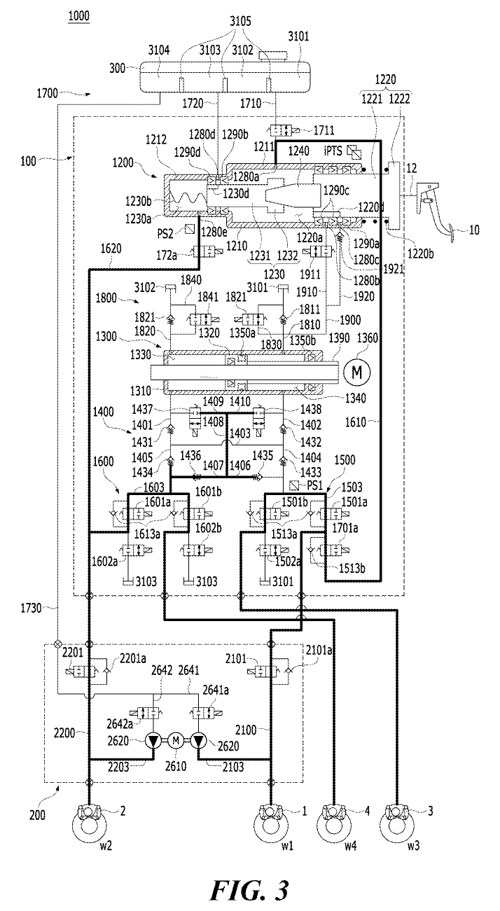

FIG. 3 is a view illustrating a supply path of a pressing medium according to the control of an auxiliary brake module of the electric brake system according to one embodiment.

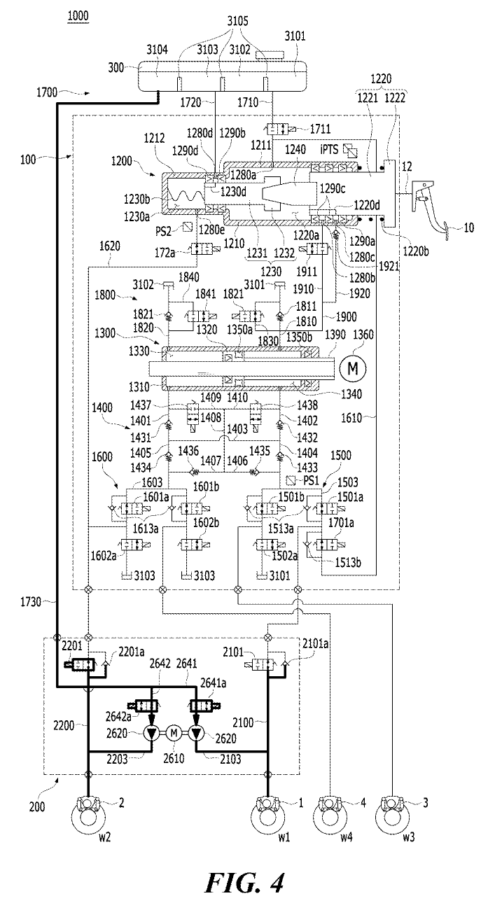

FIG. 4 is a view illustrating the supply path of the pressing medium according to the control of the auxiliary brake module of the electric brake system according to one embodiment.

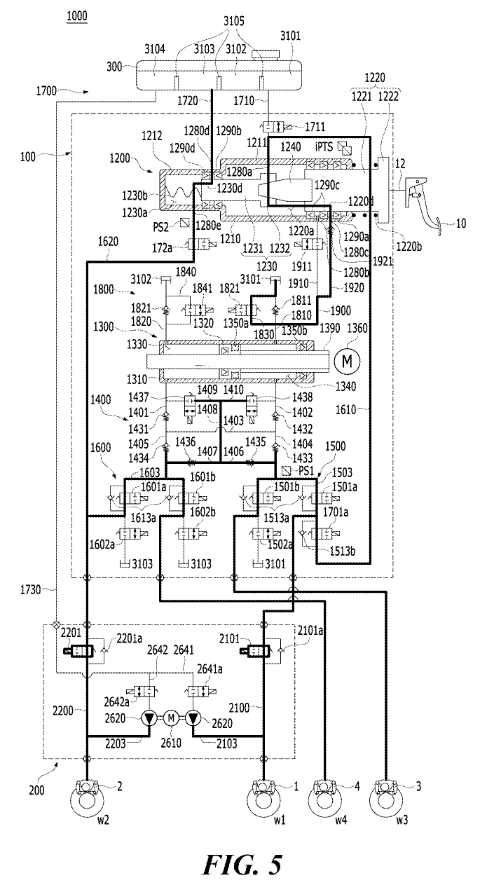

FIG. 5 is a view illustrating a discharge path and a pressure release path of the pressing medium according to the control of the auxiliary brake module of the electric brake system according to one embodiment.

Referring to FIG. 2, an electric brake system 1000 may include a main brake module 100, an auxiliary brake module 200, and/or a control circuit 400.

The main brake module 100 may be the main brake module 100 of FIG. 1 and may include a motor 1360 for generating a rotational force by a control signal of a first control circuit 4100 that receives an electrical signal of a first pedal displacement sensor 11 for a brake pedal 10, and a main valve block V1 including valves included in the main brake module 100 of FIG. 1.

The main valve block V1 may include a simulator valve 1711, a cut valve 172a, a test valve 1911, a test check valve 1921, a first inlet valve 1501a, a first outlet valve 1701a, a second inlet valve 1601a, a second outlet valve 1602a, a third inlet valve 1501b, a third outlet valve 1502a, a fourth inlet valve 1601b, a fourth outlet valve 1602b, and/or check valves 1513a, 1513b, and 1613a.

The auxiliary brake module 200 may be the auxiliary brake module 200 of FIG. 1 and may include a motor 2610 for generating a rotational force by a control signal of a second control circuit 4500 that receives an electrical signal of a second pedal displacement sensor 11′, and an auxiliary valve block V2 including valves included in the auxiliary brake module 200 of FIG. 1.

The auxiliary valve block V2 may include a first pressure control valve 2101, a second pressure control valve 2201, a first auxiliary supply valve 2641a, a second auxiliary supply valve 2642a, a first check valve 2101a, and/or a second check valve 2201a.

The control circuit 400 may include a first control circuit 4100 and a second control circuit 4500.

The first control circuit 4100 may include a plurality of semiconductor devices and may be named in various ways, such as an electronic control unit (ECU). The first control circuit 4100 may include, for example, one or more processors 4110, one or more memories 4120, and/or a communication circuit 4130.

The first control circuit 4100 may be electrically connected or communicatively connected to the second control circuit 4500 through the communication circuit 4130.

The first control circuit 4100 may receive a signal corresponding to a user’s braking intention from the first pedal displacement sensor 11 and in response thereto, may provide an electrical signal for supplying or releasing a hydraulic pressure to or from wheel cylinders 1, 2, 3, and 4 to each of a hydraulic pressure supply device 1300 and a hydraulic pressure control unit 1400.

The first control circuit 4100 may receive a signal corresponding to a rotation speed of each wheel from a first wheel speed sensor 221 provided on a first wheel w1, a second wheel speed sensor 222 provided on a second wheel w2, a third wheel speed sensor 223 provided on a third wheel w3, and a fourth wheel speed sensor 224 provided on a fourth wheel w4. In addition, the first control circuit 4100 may provide the hydraulic pressure supply device 1300 and the hydraulic pressure control unit 1400 with an electric signal for supplying or releasing a hydraulic pressure to or from each of the wheel cylinders 1, 2, 3, and 4 in response to receiving the signal corresponding to the rotation speed of each wheel from each of the wheel speed sensors 221, 222, 223, and 224 to implement an anti-lock braking system (ABS).

For example, the first control circuit 4100 may receive the signal corresponding to the user’s braking intention from the first pedal displacement sensor 11, and in response thereto, may control at least one valve and/or the motor 1360 of the main valve block V1.

The first control circuit 4100 may switch the electric brake system 1000 from a normal mode to a fallback mode when the hydraulic pressure supply device 1300 is inoperable and may transmit a signal indicating the switching to the fallback mode to the second control circuit 4500. The fallback mode is a mode in which the electric brake system 1000 maintains a minimum braking function due to the abnormal operation of the main brake module 100.

The second control circuit 4500 may include a plurality of semiconductor devices and may be named in various ways, such as an ECU. The second control circuit 4500 may include, for example, one or more processors 4510, one or more memories 4520, and/or a communication circuit 4530.

The second control circuit 4500 may be electrically connected or communicatively connected to the first control circuit 4100 through the communication circuit 4530.

The second control circuit 4500 may identify whether the first control circuit 4100 is in a normal state or an abnormal state, that is, in an inoperable state, based on, for example, the reception of the signal from the first control circuit 4100 through communication with the first control circuit 4100 through the communication circuit 4530. In addition, the second control circuit 4500 may identify whether one component of the main brake module 100 is in a normal state or an inoperable state based on, for example, reception of the signal from the first control circuit 4100 through communication with the first control circuit 4100.

The second control circuit 4500 may receive a signal indicating the switching to the fallback mode of the electric brake system 1000 through the communication circuit 4530.

In the fallback mode, the first pressure control valve 2101 and the second pressure control valve 2201, which are normal open type solenoid valves, maintain an open state, and the first auxiliary supply valve 2641a and the second auxiliary supply valve 2642a, which are normal closed type solenoid valves, maintain a closed state.

In such a state, when the brake pedal 10 is pressed, a pressing medium may be provided to a first wheel cylinder 1 and a third wheel cylinder 3 through a first connection flow path 1610, and the pressing medium may be provided to a second wheel cylinder 2 and a fourth wheel cylinder 4 through a second connection flow path 1620 from an integrated master cylinder 1200.

Referring to FIG. 3, while the first pressure control valve 2101 and the second pressure control valve 2201 maintain the open state and the first auxiliary supply valve 2641a and the second auxiliary supply valve 2642a maintain the closed state in the fallback mode, a second master chamber 1230a of the integrated master cylinder 1200 may communicate with the second wheel cylinder 2 through the second connection flow path 1620 connected to a fifth hydraulic pressure port 1280e in an open state of the integrated master cylinder 1200 and a second auxiliary connection flow path 2200 connected to the second connection flow path 1620 and provided with the second pressure control valve 2201 in the open state.

In addition, the second master chamber 1230a and the fourth wheel cylinder 4 may communicate with each other through the second connection flow path 1620, a second hydraulic pressure circuit flow path 1603 provided with the second inlet valve 1601a in the open state and the fourth inlet valve 1601b in the open state, and a flow path extending from the second hydraulic pressure circuit flow path 1603 to the fourth wheel cylinder 4. In this case, each of the second outlet valve 1602a and the fourth outlet valve 1602b is in a closed state, and the cut valve 172a is in an open state. Here, the second hydraulic pressure circuit flow path 1603 is branched from the second connection flow path 1620 and connected to the fourth wheel cylinder 4 and may be referred to as the second connection flow path 1620.

Additionally, the second hydraulic pressure circuit flow path 1603 may communicate with the bottom of a fourth valve 1434 provided on a fifth hydraulic pressure flow path 1405, a seventh hydraulic pressure flow path 1407, one side of a fifth valve 1435 provided in a sixth hydraulic pressure flow path 1406, an eighth hydraulic pressure flow path 1408, and a ninth hydraulic pressure flow path 1409 and a tenth hydraulic pressure flow path 1410 that connect a seventh valve 1437 and an eighth valve 1438.

In addition, the first master chamber 1220a and the first wheel cylinder 1 may communicate with each other through a first hydraulic pressure port 1280a in an open state of the integrated master cylinder 1200, the first outlet valve 1701a in an open state connected to the first connection flow path 1610 and provided in the first hydraulic pressure circuit flow path 1503, and a first auxiliary connection flow path 2100 provided with the first pressure control valve 2101 in an open state. In addition, the first master chamber 1220a and the third wheel cylinder 3 may communicate with each other through the first hydraulic pressure port 1280a in an open state of the integrated master cylinder 1200, the first connection flow path 1610, the first outlet valve 1701a in an open state connected to the first connection flow path 1610, the first inlet valve 1501a in an open state, the first hydraulic pressure circuit flow path 1503 provided with the third inlet valve 1501b in an open state, and the flow path extending from the first hydraulic pressure circuit flow path 1503 to the third wheel cylinder 3. In this case, the third outlet valve 1502a is in a closed state.

Accordingly, in the fallback mode, when the brake pedal 10 is pressed in the hydraulic pressure circuit state as in FIG. 3, the pressing medium may be provided to the first wheel cylinder 1 and the third wheel cylinder 3 through the first connection flow path 1610, and the pressing medium may be provided to the second wheel cylinder 2 and the fourth wheel cylinder 4 through the second connection flow path 1620 from the integrated master cylinder 1200.

The second control circuit 4500 may control at least one valve and/or the motor 2610 of the auxiliary valve block V2 upon receiving a braking request (or referred to as a demand deceleration signal) from an external controller while the hydraulic pressure supply device 1300 is inoperable.

While the hydraulic pressure supply device 1300 is inoperable, the second control circuit 4500 may close the first pressure control valve 2101 and the second pressure control valve 2201, control the first auxiliary supply valve 2641a and the second auxiliary supply valve 2642a to be opened, and drive the motor 2610.

For example, the first control circuit 4100 may transmit the braking request to the second control circuit 4500 based on a signal acquired through at least one sensor (e.g., a wheel speed sensor, a camera, etc.) of the vehicle while the hydraulic pressure supply device 1300 is inoperable. Alternatively, a vehicle control circuit (not illustrated) communicatively connected or electrically connected to the first control circuit 4100 and the second control circuit 4500 may transmit the braking request to the second control circuit 4500 while the hydraulic pressure supply device 1300 is inoperable.

The second control circuit 4500 may receive the braking request from the first control circuit 4100 or the vehicle control circuit, close the first pressure control valve 2101 and the second pressure control valve 2201 in response to the braking request, and control the first auxiliary supply valve 2641a and the second auxiliary supply valve 2642a to be opened as illustrated in FIG. 4. In addition, the second control circuit 4500 may drive the motor 2610.

Referring to FIG. 4, the pump 2620 may communicate with the reservoir 300 through a third reservoir flow path 730, a first auxiliary supply flow path 2641 connected to the third reservoir flow path 730 and provided with the first auxiliary supply valve 2641a in an open state, and a second auxiliary supply flow path 2642 connected to the first auxiliary supply flow path 2641 and provided with the second auxiliary supply valve 2642a in an open state.

In addition, the pump 2620 may communicate with the first auxiliary flow path 2103, a downstream side of the first pressure control valve 2101 in a closed state on the first auxiliary connection flow path 2100, and the first wheel cylinder 1. In addition, the pump 2620 may communicate with the second auxiliary flow path 2203, a downstream side of the second pressure control valve 2201 in a closed state on the second auxiliary connection flow path 2200, and the second wheel cylinder 2.

Accordingly, in the hydraulic pressure circuit state as in FIG. 4, when the motor 2610 is driven by the second control circuit 4500, the pressing medium may be provided to the first wheel cylinder 1 and the second wheel cylinder 2 through the third reservoir flow path 1730 from the reservoir 300, the pump 2620 via the first auxiliary supply flow path 2641 and the second auxiliary supply flow path 2642, the first auxiliary flow path 2103 and the first auxiliary connection flow path 2100 from the pump 2620, and the second auxiliary flow path 2203 and the second auxiliary connection flow path 2200.

The second control circuit 4500 may control a driving current supplied to the first pressure control valve 2101 and the second pressure control valve 2201 based on a pressure corresponding to the braking request of the external controller.

Driving current information mapped to each of a plurality of pressure information may be stored in the memory 4520.

The second control circuit 4500 may identify pressure information corresponding to the pressure corresponding to the braking request of the external controller from the driving current information mapped to each of the plurality of pressure information stored in the memory 4520 and identify the driving current information mapped to the identified pressure information.

The second control circuit 4500 may supply a current corresponding to the identified driving current information to the first pressure control valve 2101 and the second pressure control valve 2201. The first pressure control valve 2101 and the second pressure control valve 2201 may control the pressure of the first auxiliary connection flow path 2100, the first auxiliary flow path 2103, the second connection flow path 1620, and the second auxiliary flow path 2203 by controlling a blocking pressure according to the supplied driving current. Accordingly, pressures of the first wheel cylinder 1 and the second wheel cylinder 2 may be controlled.

To release the pressures of the first wheel cylinder 1 and the second wheel cylinder 2 that are pressed when the hydraulic pressure supply device 1300 is inoperable, the second control circuit 4500 may open the first pressure control valve 2101 and the second pressure control valve 2201 and close the first auxiliary supply valve 2641a and the second auxiliary supply valve 2642a.

For example, to release the pressures of the first wheel cylinder 1 and the second wheel cylinder 2 after the pressing medium is provided to the first wheel cylinder 1 and the second wheel cylinder 2 based on the driving of the motor 2610, the second control circuit 4500 may open the first pressure control valve 2101 and the second pressure control valve 2201 and close the first auxiliary supply valve 2641a and the second auxiliary supply valve 2642a. When controlling the pressures of the first wheel cylinder 1 and the second wheel cylinder 2 to be released, the second control circuit 4500 may release the driving of the motor 2610.

Referring to FIG. 5, according to the opening of the first pressure control valve 2101 and the closing of the first auxiliary supply valve 2641a, the first wheel cylinder 1 may communicate with the integrated master cylinder 1200 through the first connection flow path 1610 to discharge the pressure of the first wheel cylinder 1, that is, release the pressure. In addition, according to the opening of the second pressure control valve 2201 and the closing of the second auxiliary supply valve 2642a, the second wheel cylinder 2 may communicate with the integrated master cylinder 1200 through the second connection flow path 1620 to discharge the pressure of the second wheel cylinder 2, that is, release the pressure.

According to the opening of the first pressure control valve 2101 and the closing of the first auxiliary supply valve 2641a, the first auxiliary flow path 2103, the first auxiliary connection flow path 2100 communicating with the first wheel cylinder 1, and the first hydraulic pressure circuit flow path 1503 provided with the first and third inlet valves 1501a and 1501b in an open state and the first outlet valve 1701a in an open state may communicate with each other. In addition, a flow path for communicating the first hydraulic pressure circuit flow path 1503 with the third wheel cylinder 3 may communicate with each other. In addition, the first auxiliary connection flow path 2100 may communicate with the first reservoir chamber 3101 of the reservoir 300 via the integrated master cylinder 1200 and a first bypass flow path 1830 through the first connection flow path.

Accordingly, pressures of the first and third wheel cylinders 1 and 3 may be discharged through the first connection flow path 1610.

In addition, according to the opening of the second pressure control valve 2201 and the closing of the second auxiliary supply valve 2642a, the second auxiliary flow path 2203, the second auxiliary connection flow path 2200 communicating with the second wheel cylinder 2, the second connection flow path 1620, and the second reservoir flow path 1720 may communicate with each other. In addition, the second connection flow path 1620, the second hydraulic pressure circuit flow path 1603 provided with the second and third inlet valves 1601a and 1601b in an open state and the second and third outlet valves 1602a and 1602b in a closed state, the second hydraulic pressure circuit flow path 1603, and a flow path for communication the second hydraulic pressure circuit flow path 1603 with the fourth wheel cylinder 4 may communicate with each other.

Accordingly, pressures of the second and fourth wheel cylinders 2 and 4 may be discharged through the second connection flow path 1620.

Additionally, the first hydraulic pressure circuit flow path 1503 and the second hydraulic pressure circuit flow path 1603 may communicate with the bottom of the fourth valve 1434 provided on the fifth hydraulic pressure flow path 1405, the bottom of a third valve 1433 provided on the fourth hydraulic pressure flow path 1404, the seventh hydraulic pressure flow path 1407, the eighth hydraulic pressure flow path 1408, and the ninth hydraulic pressure flow path 1409 and the tenth hydraulic pressure flow path 1410 that connect the seventh valve 1437 to the eighth valve 1438.

Meanwhile, when the second control circuit 4500 controls the auxiliary brake module 200 to release the pressures of the first wheel cylinder 1 and the second wheel cylinder 2 when an external leak occurs on the flow path and/or when a leak cannot be recognized, that is, when the second control circuit 4500 opens the first pressure control valve 2101 and the second pressure control valve 2201 and closes the first auxiliary supply valve 2641a and the second auxiliary supply valve 2642a, a case in which the fourth reservoir chamber 3104 of the reservoir 300 is emptied may occur.

Accordingly, the second control circuit 4500 may monitor a brake fluid level (BFL) of the reservoir 300, for example, the fourth reservoir chamber 3104, and when the BFL of the fourth reservoir chamber 3104 is smaller than a predetermined reference level, the second control circuit 4500 may switch the electric brake system 1000 to the fallback mode. For example, the second control circuit 4500 may switch the electric brake system 1000 to the fallback mode when the BFL of the fourth reservoir chamber 3104 is smaller than the predetermined reference level while controlling the auxiliary brake module 200 to release the pressures of the first wheel cylinder 1 and the second wheel cylinder 2.

The second control circuit 4500 may individually control the first wheel cylinder 1 and the second wheel cylinder 2 when the hydraulic pressure supply device 1300 is inoperable.

For example, the second control circuit 4500 may sequentially repeat first control for opening the first pressure control valve 2101, closing the first auxiliary supply valve 2641a, closing the second pressure control valve 2201, and opening the second auxiliary supply valve 2642a, and second control for closing the first pressure control valve 2101, opening the first auxiliary supply valve 2641a, opening the second pressure control valve 2201, and closing the second auxiliary supply valve 2642a in a cross-control mode of the first wheel w1 provided with the first wheel cylinder 1 and the second wheel w2 provided with the second wheel cylinder 2. In addition, the second control circuit 4500 may control the motor 2601 to drive during the repetition of the first control and the second control.

For example, the second control circuit 4500 may provide an electrical signal for supplying or releasing a hydraulic pressure to or from each of the wheel cylinders 1 and 2 to the auxiliary brake module 200 in an ABS mode when the hydraulic pressure supply device 1300 is inoperable.

The second control circuit 4500 may sequentially repeat third control for opening the first pressure control valve 2101 and closing the first auxiliary supply valve 2641a, and fourth control for closing the first pressure control valve 2101 and opening the first auxiliary supply valve 2641a to implement the ABS. In addition, the second control circuit 4500 may control the motor 2601 to drive during the repetition of the third control and the fourth control.

In addition, the second control circuit 4500 may sequentially repeat fifth control for opening the second pressure control valve 2201 and closing the second auxiliary supply valve 2642a, and sixth control for closing the second pressure control valve 2201 and opening the second auxiliary supply valve 2642a to implement the ABS. In addition, the second control circuit 4500 may control the motor 2601 to drive during the repetition of the fifth control and the sixth control.

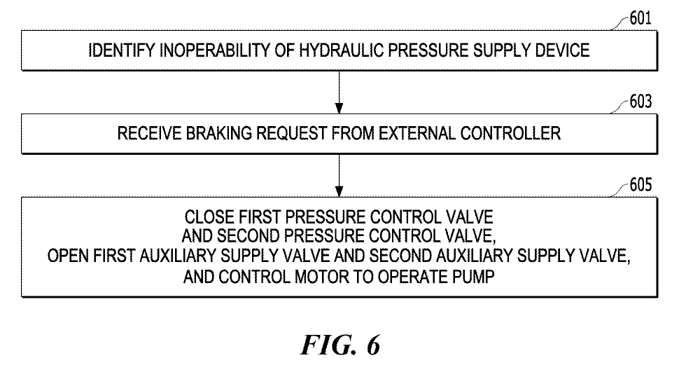

FIG. 6 is a flowchart of the operation of the electric brake system 1000 (and/or the second control circuit 4500) according to one embodiment.

Referring to FIG. 6, the electric brake system 1000 may identify the inoperability of the hydraulic pressure supply device 1300 (601).

The electric brake system 1000 may switch the electric brake system 1000 from the normal mode to the fallback mode in response to the identification of the inoperability of the hydraulic pressure supply device 1300. In this case, the first pressure control valve 2101 and the second pressure control valve 2201 may each be in an open state, and the first auxiliary supply valve 2641a and the second auxiliary supply valve 2642a may each be in a closed state.

The electric brake system 1000 may receive the braking request from an external controller during the inoperability of the hydraulic pressure supply device 1300 (603).

The electric brake system 1000 may control the motor 2601 to close the first pressure control valve 2101 and the second pressure control valve 2201, open the first auxiliary supply valve 2641a and the second auxiliary supply valve 2642a, and operate the pump 2620 upon receiving the braking request from an external controller while the hydraulic pressure supply device 1300 is inoperable (605).

In addition to the above-described embodiment of FIG. 6, when the electric brake system 1000 receives the braking request through the brake pedal 10 while the pump 2620 is being operated in the closed state of the first pressure control valve 2101 and the second pressure control valve 2201 and the open state of the first auxiliary supply valve 2641a and the second auxiliary supply valve 2642a, the electric brake system 1000 may open the first pressure control valve 2101 and the second pressure control valve 2201, close the first auxiliary supply valve 2641a and the second auxiliary supply valve 2642a, and control the motor 2601 to stop the operation of the pump 2620.

In addition, in addition to the above-described embodiment of FIG. 6, the electric brake system 1000 may control the driving current supplied to the first pressure control valve 2101 and the second pressure control valve 2201 based on the pressure corresponding to the braking request from an external controller. The first pressure control valve 2101 and the second pressure control valve 2201 may control the pressure of the first auxiliary connection flow path 2100, the first auxiliary flow path 2103, the second connection flow path 1620, and the second auxiliary flow path 2203 by controlling a blocking pressure to correspond to the supplied driving current. Accordingly, the pressures of the first wheel cylinder 1 and the second wheel cylinder 2 may be controlled.

As is apparent from the above description, the electric brake system 1000 and the method of controlling the same according to the above-described embodiments can stably and effectively implement braking in various operating situations of a vehicle.

In addition, the electric brake system 1000 and the method of controlling the same can improve braking performance and operation reliability.

In addition, the electric brake system 1000 and the method of controlling the same can be implemented to perform various braking operation modes through a simple structure and operation.

In addition, the electric brake system 1000 and the method of controlling the same can improve assemblability and productivity of a product and reduce manufacturing costs.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

1. An electric brake system comprising:
an integrated master cylinder configured to discharge a pressing medium based on operation of a brake pedal;
a hydraulic pressure supply configured to generate a hydraulic pressure of the pressing medium based on an electrical signal of a pedal displacement sensor for the brake pedal; and
an auxiliary brake configured to provide the hydraulic pressure of the pressing medium to a first wheel cylinder and a second wheel cylinder,
wherein the auxiliary brake includes:
a pump configured to press the pressing medium;
a motor configured to operate the pump;
a first auxiliary flow path configured to transfer the pressing medium pressed by the pump to the first wheel cylinder;
a first auxiliary supply flow path provided to supply the pressing medium to the pump;
a first auxiliary supply valve provided on the first auxiliary supply flow path to control the pressing medium to be supplied to the pump; and
a first pressure control valve configured to control a pressure of the pressing medium in the first auxiliary flow path.

2. The electric brake system according to claim 1, wherein the auxiliary brake further includes a second auxiliary flow path configured to transfer the pressing medium pressed by the pump to the second wheel cylinder, a second auxiliary supply flow path provided to supply the pressing medium to the pump, a second auxiliary supply valve provided on the second auxiliary supply flow path to control the pressing medium to be supplied to the pump, and a second pressure control valve configured to control a pressure of the pressing medium in the second auxiliary flow path.

3. The electric brake system according to claim 2, further comprising a control circuit configured to close the first pressure control valve and the second pressure control valve, open the first auxiliary supply valve and the second auxiliary supply valve, and control the motor to operate the pump in response to receiving a braking request from an external controller while the hydraulic pressure supply is inoperable.

4. The electric brake system according to claim 3, wherein the control circuit is configured to open the first pressure control valve and the second pressure control valve, close the first auxiliary supply valve and the second auxiliary supply valve, and control the motor to stop the operation of the pump in response to receiving a braking request from a brake pedal while the hydraulic pressure supply is inoperable.

5. The electric brake system according to claim 3, wherein the control circuit is configured to control a driving current supplied to the first pressure control valve and the second pressure control valve based on a pressure corresponding to the braking request from the external controller.

6. The electric brake system according to claim 3, wherein, when the hydraulic pressure supply is inoperable, in a fallback mode, the first pressure control valve and the second pressure control valve are in open states, and the first auxiliary supply valve and the second auxiliary supply valve are in closed states.

7. The electric brake system according to claim 3, wherein, when the hydraulic pressure supply is inoperable, in a cross-control mode of a first wheel provided with the first wheel cylinder and a second wheel provided with the second wheel cylinder, the control circuit is configured to:
repeat a first control for opening the first pressure control valve, closing the first auxiliary supply valve, closing the second pressure control valve, and opening the second auxiliary supply valve, and a second control for closing the first pressure control valve, opening the first auxiliary supply valve, opening the second pressure control valve, and closing the second auxiliary supply valve, and
control the motor to operate the pump during repetition of the first control and the second control.

8. The electric brake system according to claim 1, wherein the integrated master cylinder includes:
a first master piston displaceable by operation of the brake pedal;
a first master chamber whose volume changes according to displacement of the first master piston;
a second master piston displaceable by the displacement of the first master piston or a hydraulic pressure of the first master chamber; and
a second master chamber whose volume changes according to displacement of the second master piston.

9. The electric brake system according to claim 8, further comprising:
a reservoir;
a first reservoir flow path connecting the first master chamber to the reservoir;
a second reservoir flow path connecting the second master chamber to the reservoir; and
a third reservoir flow path connected to the first auxiliary supply flow path and the second auxiliary supply flow path to allow the pump to communicate with the reservoir.

10. The electric brake system according to claim 9, further comprising:
a first connection flow path provided with the first pressure control valve to connect the first wheel cylinder to the master cylinder; and
a second connection flow path provided with the second pressure control valve to connect the second wheel cylinder to the master cylinder.

11. An electric brake system comprising:
a main brake connected to a brake pedal and mechanically and electronically operated to supply a hydraulic pressure of a pressing medium;
an auxiliary brake including:
a pump configured to press the pressing medium;
a motor configured to operate the pump;
a first auxiliary flow path and a second auxiliary flow path that transfer the pressing medium pressed by the pump to a first wheel cylinder and a second wheel cylinder, respectively;
a first auxiliary supply flow path and a second auxiliary supply flow path provided to supply the pressing medium to the pump;
a first auxiliary supply valve provided on the first auxiliary supply flow path to control the pressing medium to be supplied to the pump;
a second auxiliary supply valve provided on the second auxiliary supply flow path to control the pressing medium to be supplied to the pump; and
a first pressure control valve and a second pressure control valve configured to control pressures of the pressing medium in the first auxiliary flow path and the second auxiliary flow path; and
a control circuit configured to control at least one of the first pressure control valve, the second pressure control valve, the first auxiliary supply valve, the second auxiliary supply valve, or the motor of the auxiliary brake while the main brake is inoperable.

12. The electric brake system according to claim 11, wherein the control circuit is configured to close the first pressure control valve and the second pressure control valve, open the first auxiliary supply valve and the second auxiliary supply valve, and control the motor to operate the pump in response to receiving a braking request from an external controller while the main brake is inoperable.

13. The electric brake system according to claim 12, wherein the control circuit is configured to open the first pressure control valve and the second pressure control valve, close the first auxiliary supply valve and the second auxiliary supply valve, and control the motor to stop the operation of the pump in response to receiving the braking request from a brake pedal while the main brake is inoperable.

14. The electric brake system according to claim 12, wherein the control circuit is configured to control a driving current supplied to the first pressure control valve and the second pressure control valve based on a pressure corresponding to the braking request from the external controller.

15. The electric brake system according to claim 12, wherein, when the hydraulic pressure supply is inoperable, in a fallback mode, the first pressure control valve and the second pressure control valve are in open states, and the first auxiliary supply valve and the second auxiliary supply valve are in closed states.

16. A method of controlling an electric brake system, comprising:
in response to receiving a braking request while a main brake of the electric brake system is inoperable, closing pressure control valves and opening auxiliary supply valves of an auxiliary brake that provides hydraulic pressure of a pressing medium to wheel cylinders; and
controlling a motor that operates a pump based on the closing of the pressure control valves and the opening of the auxiliary supply valves, the pump generating the hydraulic pressure of the pressing medium,
wherein the auxiliary supply valves control a supply of the pressing medium to the pump, and the pressure control valves control pressures of the pressing medium transferred from the pump to respective wheel cylinders.

17. The method according to claim 16, further comprising opening the pressure control valves, closing the auxiliary supply valves, and controlling the motor to stop the operation of the pump in response to receiving the braking request from a brake pedal while the main brake is inoperable.

18. The method according to claim 16, further comprising controlling a driving current supplied to the pressure control valves based on a pressure corresponding to the braking request received from an external controller.

19. The method according to claim 16, wherein, when the main brake is inoperable, in a fallback mode, the pressure control valves are opened, and the auxiliary supply valves are closed.

20. The method according to claim 16, further comprising, when the main brake is inoperable, in a cross-control mode of a first wheel provided with a first wheel cylinder and a second wheel provided with a second wheel cylinder, repeating a first control for opening a first pressure control valve, closing a first auxiliary supply valve, closing a second pressure control valve, and opening a second auxiliary supply valve, and a second control for closing the first pressure control valve, opening the first auxiliary supply valve, opening the second pressure control valve, and closing the second auxiliary supply valve; and
controlling the motor to operate the pump during repetition of the first control and the second control.
